(19) United States
(12) Patent Application Publication
(10) Pub. No.: US 2004/0253420 A1
(43) Pub. Date: Dec. 16, 2004

(54) Method for manufacturing a work of art using a color printer

(76) Inventor: Lawrence J. Longobardi, Olivenhain, CA (US)

Correspondence Address: NEIL K. NYDEGGER, NYDEGGER & ASSOCIATES, 348 Olive Street, San Diego, CA, 92103, US

(21) Appl. No.: 10/658,642

(22) Filed: Sep. 9, 2003

Related U.S. Application Data
(63) Continuation-in-part of application No. 10/459,269, filed on Jun. 11, 2003.

(51) Int. Cl. B32B 3/00

(52) U.S. Cl. 428/195.1

(57) ABSTRACT

An original work of art incorporates various layers of different materials in a predetermined order. First, is the base substrate. Next, a relief layer having ink deposits that present textural and tonal contrasts for the work of art are applied to the substrate. A computerized color print layer is then combined with the relief layer to create the work of art. For substrates having a reflective surface, a white layer can be added between the substrate and the relief layer to selectively reduce reflectivity in the work of art.

This application is a continuation-in-part of application Ser. No. 10,459,269, filed Jun. 11, 2003, which is currently pending. The contents of application Ser. No. 10,459,269 are incorporated herein by reference.

### FIELD OF THE INVENTION

The present invention pertains generally to devices and implements for creating original works of fine art using computerized techniques. More particularly, the present invention pertains to visual works of art having physical enhancements for the presentation of shading depth and definition. The present invention is particularly, but not exclusively useful for creating original works of art using a computerized color printer.

### BACKGROUND OF THE INVENTION

All works of art involve the making or doing of things that display form, beauty, and an unusual or unique perception. In the case of fine art, the characteristics of the work are distinguished by their purely aesthetic value. More particularly, insofar as fine art paintings are concerned, the aesthetic value of a particular work is found not only in its presentation, but also in the contrasts that are introduced into the work by the artist. These contrasts can be either textural or tonal in nature, and will include the shadings, depth and definition that make the artwork extraordinary and unique.

Reproductions of an original artwork, like the original itself, can also be valuable. The value of a reproduction, however, depends in large part on how faithful the reproduction is in its presentation of the original. For instance, in the reproduction of an oil painting, the ability to accurately incorporate the contrasts that were made by the artist in the original, may greatly enhance the value of the reproduction. Depending on the particular work of art, these contrasts can be many and varied, and will include such nuances as brush strokes and color variations. It is almost needless to say that the contrasts which add so much to a work of fine art are often subtle and, accordingly, quite difficult to reproduce.

Various devices and techniques have been developed over recent years for the reproduction of visual works. Of particular interest here are the so-called color printers that can accurately reproduce the colors of an original subject. In general, color printing is achieved by any of several printing processes wherein each color is printed separately, in a predetermined order. The superimposed impression, when accurately registered, then builds up an image that corresponds in color to the original subject. Recently, color print processes have been greatly improved by incorporating computer control over the printing process.

Though very effective, color print processes are somewhat limited by the physical characteristics of the inks that are used in the process. Of particular importance in this regard is the viscosity, or resistance to flow, of the inks that are used. Typically, for operational reasons, the inks that are used in color print processes have rather low viscosities, i.e. they are thin and flow easily. Thus, although the colors in an original work of art may be accurately reproduced using a color print process, the result is an essentially two-dimensional presentation. Consequently, a color print process, alone, will not produce the three-dimensional contrasts that are of crucial importance for the accurate presentation of a work of fine art.

It is known that inks having viscosities which are much greater than the viscosities required for use in a color print process can be used to provide three-dimensional effects for a reproduced work of art. Specifically, it is known that extremely viscous inks (i.e. so-called “thick” inks) can be effectively incorporated into a reproduced work of art by using screen printing processes. For example, U.S. Pat. No. 4,933,218, which issued to Longobardi for an invention entitled “Sign with Transparent Substrate” discloses the use of screen printing to achieve a three-dimensional effect in an artwork by incorporating an “extremely thick ridge of ink” into the artwork. Ridges alone, however, do not recreate the textural and tonal contrasts found in a work of fine art.

In light of the above, it is an object of the present invention to provide a reproduction of an original work of art, and a method for manufacturing the same, which includes the textural and tonal contrasts that are presented in the original work of art. Another object of the present invention is to provide a reproduction of an original work of art, and a method for manufacturing the same, wherein a screen printing process and a color printing process are used together, in combination, to recreate the contrasts that are found in a work of fine art, and to incorporate these contrasts into a reproduction of the original. Still another object of the present invention is to provide a reproduction of an original work of art, and a method for manufacturing the same, which is easy to implement and comparatively cost effective.

### SUMMARY OF THE INVENTION

In accordance with the present invention a method for creating a reproduction of an original work of art is disclosed wherein the textural and tonal contrasts created by the artist in the original artwork are presented in the reproduction. In overview, the methods and products that are disclosed for the present invention involve the creation and combination of various layers of materials. Importantly, the combination of these various layers subsequently serve as the foundation for a color print process.

For the present invention, a base substrate is provided that has a substantially flat surface. The surface may be either reflective or non-reflective, and it may be of any desired color. Also, the base substrate may be made of paper stock or it may be made of a reflective material, such as aluminum sheeting. Further, if made of paper stock, the base substrate may be coated, or uncoated, or covered with a metallic foil.

A key aspect of the present invention is that a relief layer is applied to the surface of the substrate. Importantly, this relief layer has ink deposits that are dimensioned and arranged to correspond with the contrasts that were created by the artist in the original work of art. Preferably, the relief layer will include a clear plastic sheet on which the ink deposits have been placed. This clear plastic sheet, along with the ink deposits, can then be bonded directly onto the surface of the base substrate. Alternatively, the clear plastic sheet need not be used and, instead, the ink deposits can be placed directly onto the base substrate. In either case, the ink deposits of the relief layer are created by a screen printing process using a thick, extremely viscous ink.

After being screen printed, the viscous ink deposits of the relief layer can be further refined by manually using other tools, such as a brush or spatula. The purpose in using these various tools is to refine the contrasts that are being incorporated into the reproduction. For example, in the specific case of an oil painting, the contrasts may be refined to give an impression of brush strokes in the reproduction. Further, in order to give the reproduction additional texture, depth and definition, the relief layer can be made by selectively using clear or color tinted inks for the ink deposits.

Whenever the surface of the base substrate is reflective in nature, an optional white layer can be used for the present invention. If used, this white layer will be positioned between the reflective surface of the substrate and the relief layer to provide an opacity that will diminish the reflectivity of selected portions of the reflective surface. Like the relief layer, this white layer is preferably created by a screen printing process. Also, like the relief layer, the white layer may include a clear substrate which can then be bonded to the surface of the base substrate. If a white layer is used, the relief layer would be applied onto the white layer.

Once the various layers have been combined as indicated above, a color print layer is positioned over the relief layer to provide the reproduction with a color replication of the work of art being reproduced. Preferably, for all embodiments of the present invention, the relief layer is located between the surface of the substrate and the color print layer. In this combination, the ink deposits of the relief layer are incorporated into the color replication of the color print layer as contrasts from the original work of art.

As envisioned for the present invention, the positioning of the color print layer can be computerized. Specifically, the color print layer will include a plurality of variously colored ink dots that are deposited onto the relief layer according to the instructions of a computer program. The computer program is also employed to register the color print layer with the relief layer.

In addition to making reproductions of other works of art, the methods and processes of the present invention are also applicable for the creation of original works of art. To do this, the artist prepares a computer program for the color print layer according to his/her desires. This computer program is then used to control a color printer for the generation of the color print layer. The relief layer is also prepared by the artist according to his/her desires and, in a first step, is placed or applied to the substrate by a silk screening process. The silk screening can then be enhanced by whatever further refinements may be wanted by the artist. As mentioned above, refinements to the relief layer can be manually introduced by the artist. Specifically is can be done using tools, such as a brush or spatula. Similarly, an optional white layer can be prepared by the artist and incorporated in the manner discussed above. The substrate with its relief layer and white layer (optional) can then be run through the color printer to create the original work of art.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an elevational view of a reproduction of a work of fine art in accordance with the present invention;

FIG. 2 is a cross sectional view of the reproduction as seen along the line 2-2 in FIG. 1;

FIG. 3 is an exploded perspective view of the fine art reproduction according to the present invention, showing various layers of the reproduction positioned for combined incorporation; and

FIG. 4 is a schematic representation of a method for manufacturing a fine art reproduction in accordance with the present invention.

### DESCRIPTION OF THE PREFERRED EMBODIMENTS

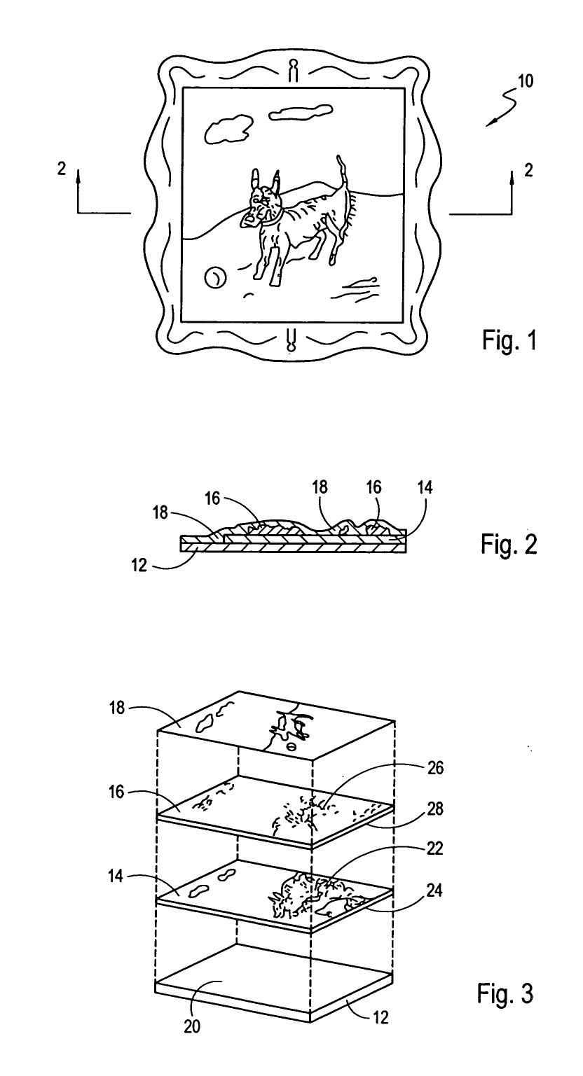

Referring initially to FIG. 1, a reproduction of fine art that has been manufactured in accordance with the present invention is shown and is generally designated 10. More particularly, the construction of the reproduction 10 will be best appreciated with reference to FIG. 2. There it will be seen that the reproduction 10 essentially includes a base substrate 12 on which a white layer 14 has been deposited. Additionally, there is a relief layer 16 and a color print layer 18 which overlies the base substrate 12 to place both the white layer 14 and the relief layer 16 between the base substrate 12 and the color print layer 18. The actual construction of the reproduction 10 will, perhaps, be best appreciated by cross referencing FIG. 2 with FIG. 3, and by individually considering each portion of the construction.

For purposes of the present invention, the base substrate 12 may be made of paper stock, metal sheeting (e.g. aluminum), or any other type of suitable material known in the pertinent art. Regardless of the material used for base substrate 12, and although the base substrate 12 may be shaped as desired (the rectangular shape shown in FIG. 3 is only exemplary), the base substrate 12 will preferably have a substantially flat surface 20. As envisioned for the present invention, the surface 20 may be either reflective or non-reflective.

In the event that the surface 20 of base substrate 12 is reflective in nature, the reproduction 10 may include the white layer 14. Use of the white layer 14, however, is optional. If used, the white layer 14 will include a white opaque ink 22 that may be selectively placed on a clear plastic sheet 24. The white layer 14 is then placed against the surface 20 of base substrate 12 with the white ink 22 covering selected portions of the surface 20. Alternatively, the white layer 14 need not include the clear sheet 24 and, instead, the white ink 22 may be applied directly to the selected portions of the surface 20. In either case, the purpose of the white ink 22 of white layer 14 is to provide an opacity that will effectively diminish the reflectivity of the selected portions of the surface 20. Recall, this white layer 14 is optional. If the surface 20 of base substrate 12 is not reflective, the white layer 14 may not be needed.

FIG. 3 shows that the relief layer 16 will include deposits of a viscous ink 26. Preferably, the ink 26 will be clear and will have a relatively high viscosity. The ink 26 may, however, be color tinted. Importantly, and regardless of color, the viscosity of ink 26 must allow the deposits of ink 26 to be configured as needed. Specifically, the deposits of ink 26 in relief layer 16 must be capable of being varied in extent, depth and orientation within the relief layer 16. The purpose here is to have the deposits of ink 26 replicate, or mimic, the textural and tonal contrasts that are found in the original artwork.

As also shown in FIG. 3, the deposits of ink 26 may be placed on a clear plastic sheet 28. Like the white layer 14 discussed above, however, the relief layer 16 need not include the clear sheet 28. In any event, with or without the clear sheet 28, the deposits of ink 26 in relief layer 16 are placed over the white layer 14. If the white layer 14 is not used, the relief layer 16 may be placed directly against the surface 20 of base substrate 12.

Still referring to FIG. 3, it will be appreciated that the color print layer 18 covers the other layers 14 (if used) and 16. The sole purpose of the color print layer 18 is to provide a faithful color replication of the artwork being reproduced. Preferably, the color variations of the original artwork are replicated in the color print layer 18 by a computer program that has been prepared and written in accordance with techniques that are well known in the computer art. Thus, as envisioned for the reproduction 10 of the present invention, the color print layer 18 is digitally colorized using known computer techniques.

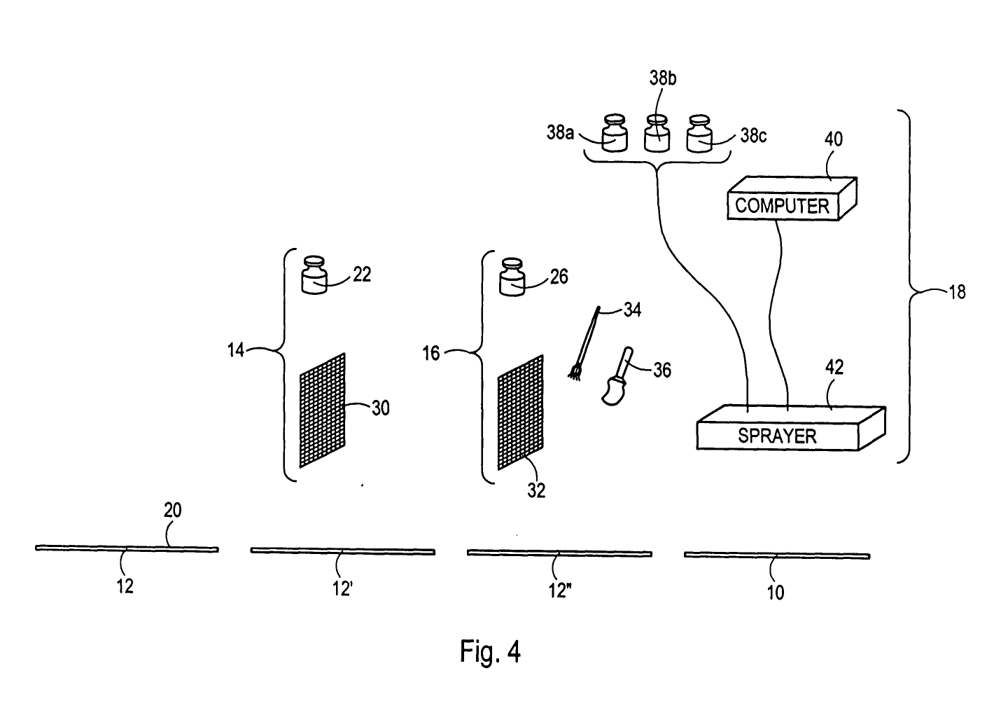

Referring now to FIG. 4, a schematic representation of a process for manufacturing a reproduction 10 in accordance with the present invention is shown. With reference to FIG. 4 it is to be appreciated that, if used, the white layer 14 is placed on the surface 20 to create a base substrate 12′. Preferably, this is done by a screen printing process wherein the white ink 22 is passed through a mask (not shown) that has been positioned on a mesh 30. As is well known in the pertinent art, this process will result in the white ink 22 being applied to only the selected portions of the surface 20 that are not covered by the mask.

Even though a white layer 14 may not be used, the relief layer 16 is applied to create a base substrate 12″. As indicated in FIG. 4, the relief layer 16 can be applied to the base substrate 12″ in a variety of ways using the viscous ink 26. Specifically, deposits of the viscous ink 26 can be applied to the base substrate 12 using a screen printing process. In FIG. 4, this screen printing process is represented by the mesh 32 which can be used with a mask (not shown) in a manner similar to that disclosed above with reference to the white layer 14. Alternatively, or in addition to the screen printing process, deposits of the viscous ink 26 can be manually applied to the base substrate 12 by using a brush 34 or a spatula 36. Regardless of the particular tool that is used in this task, it is most important that the contrasts found in the original artwork are replicated by the deposits of viscous ink 26 in the relief layer 16 for the reproduction 10. As mentioned above, these contrasts will be both tonal and textural in nature.

Once the relief layer 16 has been applied to the base substrate 12″, the color print layer 18 is then incorporated to create the reproduction 10. Specifically, as indicated in FIG. 4, the process of incorporating the color print layer 18 into the reproduction 10 is computerized. As with any well known color print process, the present invention envisions the use of a plurality of variously colored inks 38, of which the colored inks 38a, 38b and 38c shown in FIG. 4 are only exemplary. The individual sources of these colored inks 38, as well as a computer 40, are respectively connected to a sprayer 42. More specifically, the computer 40 is electronically connected to the sprayer 42 and, in accordance with a previously prepared computer program (not shown), the computer 40 controls the flow of the respective colored inks 38 through the sprayer 42 to create the color print layer 18. Thus, in order from front to rear, a reproduction 10 in accordance with the present invention includes, the color print layer 18, the relief layer 16, the white layer 14 (optional), and the substrate 12.

When using the techniques and methods of the present invention for the creation of an original work of art, the artist assumes total control over the creation of the various layers 14, 16 and 18. In particular, by exploiting the relatively thick viscosity of the ink 26 that is used to create the relief layer 16, the artist is able to incorporate physical enhancements for the color print layer 18 that would not be possible, otherwise. More specifically, as envisioned by the present invention, for the creation of an original work of art, the artist is free to separately and individually manipulate the white layer 14, the relief layer 16, and the color print layer 18, as desired. Moreover, by introducing variations in at least one of the other layers (e.g. the white layer 14, or the relief layer 16), while using a same color print layer 18, the artist is able to create different original works which all have a same theme or color scheme, but which all have different contrasts. More specifically, the computerized color print layer 18 can be used to establish a same theme or color scheme for different works. With a common theme or color scheme, reconfigurations of the white layer 14 and/or the relief layer 16 can be made from work to work, to create variations in extent, depth and orientation that will give each work its own original textural and tonal contrasts. As will be appreciated by the skilled artisan, the color scheme of a theme, or the theme itself, can also be changed from work to work, while the relief layer 16 or the white layer 14 (if used) remain the same. In each case, for each new work of art, the color print layer 18 is applied using a computerized color printer (i.e. computer 40 and sprayer 42).

While the particular Method for Manufacturing a Work of Art Using a Color Printer as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for creating an original work of art which comprises the steps of:
programming a computerized color printer with a computer program to generate a color print layer;
providing a base substrate having a surface;
applying a relief layer onto the surface of the substrate wherein the relief layer includes deposits of viscous ink;
configuring the deposits of viscous ink of the relief layer in dimension and arrangement to create textural and tonal contrasts for the work of art; and
using the color printer to apply the color print layer to the substrate over the relief layer, to incorporate the deposits of viscous ink in the relief layer into the color print layer for a combined presentation thereof in the work of art.

2. A method as recited in claim 1 wherein the applying step comprises the steps of:
screen printing the ink deposits onto a clear substrate; and
bonding the clear substrate, with ink deposits thereon, to the surface of the base substrate.

3. A method as recited in claim 2 wherein the configuring step is accomplished manually.

4. A method as recited in claim 3 further comprising the step of creating a plurality of original works of art by selectively reconfiguring the relief layer for each original work of art.

5. A method as recited in claim 1 wherein the applying step is accomplished by screen printing the relief layer directly onto the surface of the substrate.

6. A method as recited in claim 1 wherein the ink deposits are made with a clear viscous ink.

7. A method as recited in claim 1 wherein the surface of the base substrate is reflective and said method further comprises the step of incorporating a white layer between the reflective surface of the substrate and the relief layer to provide opacity to diminish the reflectivity of selected portions of the reflective surface.

8. A method as recited in claim 7 wherein the incorporating step comprises the steps of:
screen printing white ink placed onto selected portions of a clear substrate; and
bonding the clear substrate with white ink thereon to the surface of the substrate.

9. A method as recited in claim 8 further comprising the step of creating a plurality of original works of art by selectively reconfiguring the white ink for each original work of art.

10. A method as recited in claim 1 further comprising the step of employing the computer program to register the color print layer with the relief layer.

11. A method as recited in claim 1 wherein the color print layer comprises a plurality of variously colored ink dots.

12. An original work of art comprising:
a base substrate having a surface;
a computerized color print layer for providing a color theme for the work of art; and
a relief layer of ink deposits applied to the surface of said substrate and configured in dimension and arrangement to create textural and tonal contrasts for the work of art, wherein the relief layer is located between the surface of the substrate and the color print layer as the color print layer is being applied over the relief layer by a computerized color printer to incorporate the ink deposits of the relief layer into the color print layer for a combined presentation thereof in the work of art.

13. An original work of art as recited in claim 12 wherein the relief layer comprises a clear substrate with the ink deposits presented thereon.

14. An original work of art as recited in claim 13 wherein the ink deposits are screen printed onto the clear substrate.

15. An original work of art as recited in claim 14 wherein the ink deposits are made with a clear viscous ink.

16. An original work of art as recited in claim 12 wherein the surface of said base substrate is reflective and said reproduction further comprises a white layer positioned between the reflective surface of said substrate and said relief layer to provide opacity to diminish the reflectivity of selected portions of the reflective surface.

17. An original work of art as recited in claim 16 wherein the white layer comprises:
a clear substrate; and
white ink placed onto selected portions of the clear substrate.

18. An original work of art as recited in claim 17 wherein placement of the white ink on the clear substrate is accomplished by screen printing.

19. An original work of art as recited in claim 12 wherein the surface of said base substrate has a flat appearance and said relief layer is applied directly onto the surface of said substrate.

20. An original work of art as recited in claim 19 wherein the surface of said substrate is white.
